(19) United States
(12) Patent Application Publication
(10) Pub. No.: US 2006/0069616 A1
(43) Pub. Date: Mar. 30, 2006

(54) Determining advertisements using user behavior information such as past navigation information

(76) Inventor: David Bau, Gladwyne, PA (US)

Correspondence Address: STRAUB & POKOTYLO, 620 TINTON AVENUE, BLDG. B, 2ND FLOOR, TINTON FALLS, NJ, 07724, US

(21) Appl. No.: 10/955,828

(22) Filed: Sep. 30, 2004

(51) Int. Cl. G06Q 30/00

(52) U.S. Cl. 705/14

(57) ABSTRACT

Ads better targeted to individual users can be determined by using (recent) navigation history. User navigation (e.g., Web browsing) may be tracked, recorded and maintained. The navigation history information, and perhaps information about a current document, may be used to determine content-relevant and personalized ads. By doing so the ads seen by the user are more interesting and relevant to a current user interest inferred from their (recent) navigation.

### § 1. BACKGROUND OF THE INVENTION

§ 1.1 Field of the Invention

The present invention concerns advertising. In particular, the present invention concerns helping advertisers and Websites to present better targeted and more user-relevant ads.

§ 1.2 Related Art

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.) Query keyword-relevant advertising has been used by search engines. The AdWords advertising system by Google of Mountain View, Calif. is one example of query keyword-relevant advertising. Similarly, content-relevant advertising systems have been proposed. For example, U.S. patent application Ser. No. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content-relevant advertising, such as the AdSense advertising system by Google, has been used to serve ads on Web pages.

Other ad placement technology may use navigation history information of users browsing the Internet when delivering ads. However, current methods of ad delivery based on navigation history information have problems. For example, ad delivery by DoubleClick can use only history information that can be gleaned from activity on pages that have DoubleClick ads. Unfortunately, since that history information is often sparse and incomplete, the ads delivered could be better targeted.

Spyware approaches such as those used by Gator can collect full navigation history, but present ads in an intrusive, often annoying way to the user. Specifically, since these products generate popup ads over Websites without the permission of such Websites, these products are generally seen by users as unfriendly, undesirable programs.

### § 2. SUMMARY OF THE INVENTION

The present invention may be used to improve ad delivery. The present invention may do so by having a client device track a history of documents of a first type and documents of a second type requested by the client device, generate and store navigation history information from the tracked history of documents, and generate, after requesting a document of the first type, an ad request including at least some of the navigation history information.

The client device may then forward the ad request towards an ad delivery system. The documents of the first type have an ad serving agreement with the ad delivery system, and documents of the second type have no ad serving agreement with the ad delivery system. In at least some embodiments consistent with the present invention, the ad delivery system is a content-relevant ad delivery system. In such embodiments, the ad request may include document information.

The ad delivery system may then determine a set of one or more ads using at least some of the at least some navigation history information in the ad request, and forward the determined set of ads towards the client device. The client device may then receive the determined set of ads, and render the determined set of ads with the document of the first type loaded.

In at least one embodiment consistent with the present invention, the navigation history information may be encrypted. The navigation history information may include a unique identifier, such as, for example, a unique identifier of the client device.

In at least one alternative embodiment consistent with the present invention, ad requests and navigation history information may be sent to the ad delivery system independently.

### § 3. BRIEF DESCRIPTION OF THE DRAWINGS

FIG. 1 is a diagram showing parties or entities in a network environment in which the present invention may be used.

FIG. 2 is a bubble chart of an exemplary user device (client) operations and, information used or generated by such operations, consistent with the present invention.

FIG. 3 is a bubble chart of exemplary content-relevant ad serving operations, and information used or generated by such operations, consistent with the present invention.

FIG. 4 is a flow diagram illustrating acts that may be performed under the present invention.

FIG. 5 is flow diagram of an exemplary method that may be used to track user navigation and generate navigation history information in a manner consistent with the present invention.

FIG. 6 is a flow diagram of an exemplary method that may be used to request and render ads, using navigation history information in a manner consistent with the present invention.

FIG. 7 is a flow diagram of an exemplary method that may be used to generate a set of one or more ads using navigation history information in a manner consistent with the present invention.

FIGS. 8A-8C are messaging diagrams illustrating the communication of various information among parties or entities in a manner consistent with the present invention.

FIG. 9 illustrates a document, such as a Webpage for example, including code for generating an ad request including client navigation history.

FIG. 10 is a high-level block diagram of apparatus that may be used to perform at least some operations and store at least some information consistent with the present invention.

### § 4. DETAILED DESCRIPTION

The present invention may involve novel methods, apparatus, message formats, and/or data structures for helping to serve useful content-relevant ads using the navigation history information of a user. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventor regards his invention as any patentable subject matter described.

In the following, definitions of terms that may be used in this specification are provided in §4.1. Then, environments in which, or with which, the present invention may operate are described in § 4.2. Then, exemplary embodiments of the present invention are described in § 4.3. Examples of operations are provided in § 4.4. Finally, some conclusions regarding the present invention are set forth in § 4.5.

§ 4.1 Definitions

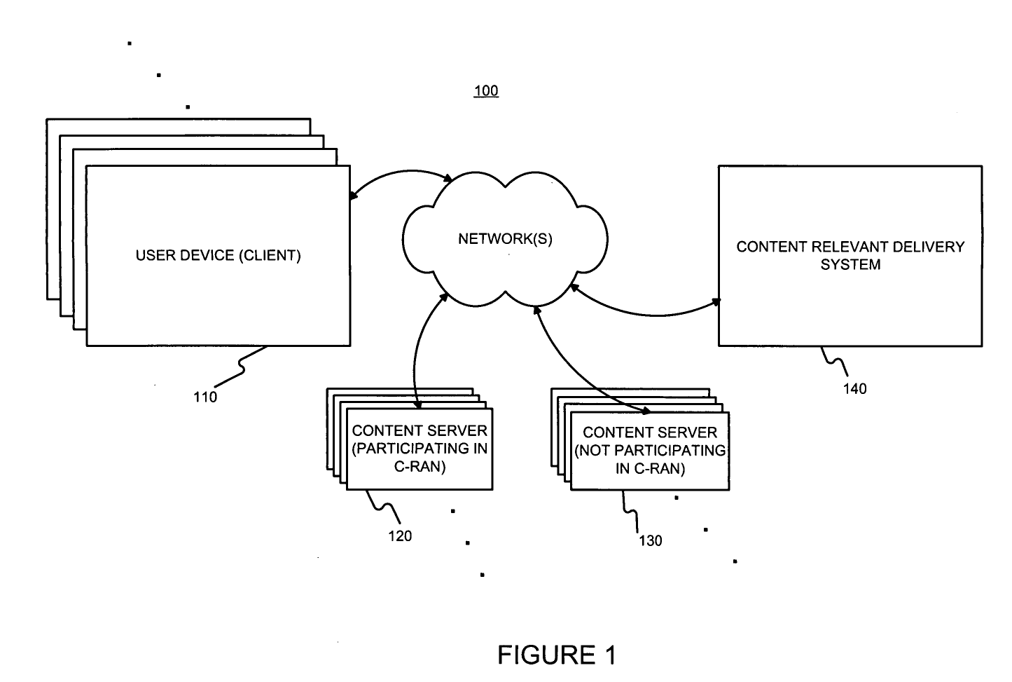

Online ads, such as those used in the exemplary systems described above with reference to FIGS. 1, 2, and 3 or any other system, may have various features. Such features may be specified by an application and/or an advertiser. These features are referred to as “ad features” below. For example, in the case of a text ad, ad features may include a title line, ad text, executable code, an embedded link, etc. In the case of an image ad, ad features may additionally include images, etc. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a page on which the ad is served (including one or more topics or concepts determined to be associated with the page, information or content located on or within the page, information about the page such as the host of the page (e.g. AOL, Yahoo, etc.), the importance of the page as measured by e.g. traffic, freshness, quantity and quality of links to or from the page etc., the location of the page within a directory structure, etc.), a search query or search results associated with the serving of the ad, a user characteristic (e.g., their geographic location, the language they use, the type of browser used, previous page views, previous behavior), a host or affiliate site (e.g., America Online, Google, Yahoo) that initiated the request that the ad is served in response to, an absolute position of the ad on the page on which it is served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as conditions or constraints. When used as serving conditions or constraints, such serving parameters are referred to simply as “serving constraints”. For example, in some systems, an advertiser may be able to specify that its ad is only to be served on weekdays, no lower than a certain position, only to users in a certain location, etc. As another example, in some systems, an advertiser may specify that its ad is to be served only if a page or search query includes certain keywords or phrases.

“Ad information” may include any combination of ad features, ad serving constraints, information derivable from ad features or ad serving constraints (referred to as “ad derived information”), and/or information related to the ad (referred to as “ad related information”), as well as an extensions of such information (e.g., information derived from ad related information).

A “document” is to be broadly interpreted to include any machine-readable and machine-storable work product. A document may be a file, a combination of files, one or more files with embedded links to other files, etc.; the files may be of any type, such as text, audio, image, video, etc. Parts of a document to be rendered to an end user can be thought of as “content” of the document. Ad spots in the document may be defined by embedded information or instructions. In the context of the Internet, a common document is a Web page. Web pages often include content and may include embedded information (such as meta information, hyperlinks, etc.) and/or embedded instructions (such as Javascript, etc.). In many cases, a document has a unique, addressable, storage location and can therefore be uniquely identified by this addressable location. A universal resource locator (URL) is a unique address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer or Netscape), a media player (e.g., an MP3 player, a Realnetworks streaming audio file player, etc.), a viewer (e.g., an Abobe Acrobat pdf reader), etc.

§ 4.2 Environments in which, or with which, the Present Invention May Operate

§ 4.2.1 Exemplary Advertising Environment

FIG. 1 is a diagram showing parties or entities in a network environment in which the present invention may be used. The invention uses navigation history information when determining ads to be delivered to a user device. Doing so improves the relevance of the ads to a user. The environment includes one or more user devices (clients) 110, a content-relevant ad delivery system 140, and content servers 120, 130. Some of the content servers 120 may partner with the content-relevant ad delivery system 140, thereby defining a content-relevant ad network (C-RAN). Other content servers 130 might not belong to the C-RAN.

A user device 110 may track navigation (e.g., browsing) and maintain a navigation history. The user device 110 may request documents (e.g., Web pages) from the content servers 120/130. If it 110 requests for content from a content server participating in the C-RAN 120, it may receive content from the content server 120 and ads relevant to content of documents associated with the user's navigation history, and perhaps relevant to the currently requested document, from the content-relevant ad delivery system 140. If the content-relevant ad delivery system 140 does not get navigation history information from the user device 110 (e.g., the content-server participating in C-RAN does not detect a navigation history object file along with the request for content), then the user device 110 may receive the requested document and ads relevant to only the current document content (and perhaps non-document information). The user device 110 may also request a document from content servers not participating in C-RAN 130. In this case, the user device 110 may only receive the requested document and ads only relevant to the content of the current document. In at least some embodiments, the navigation history information is available only to content servers participating in C-RAN 120. Requests for ads to the content-relevant ad delivery system 140 may be sourced from a content server participating in the C-RAN 120, or from the user device 110.

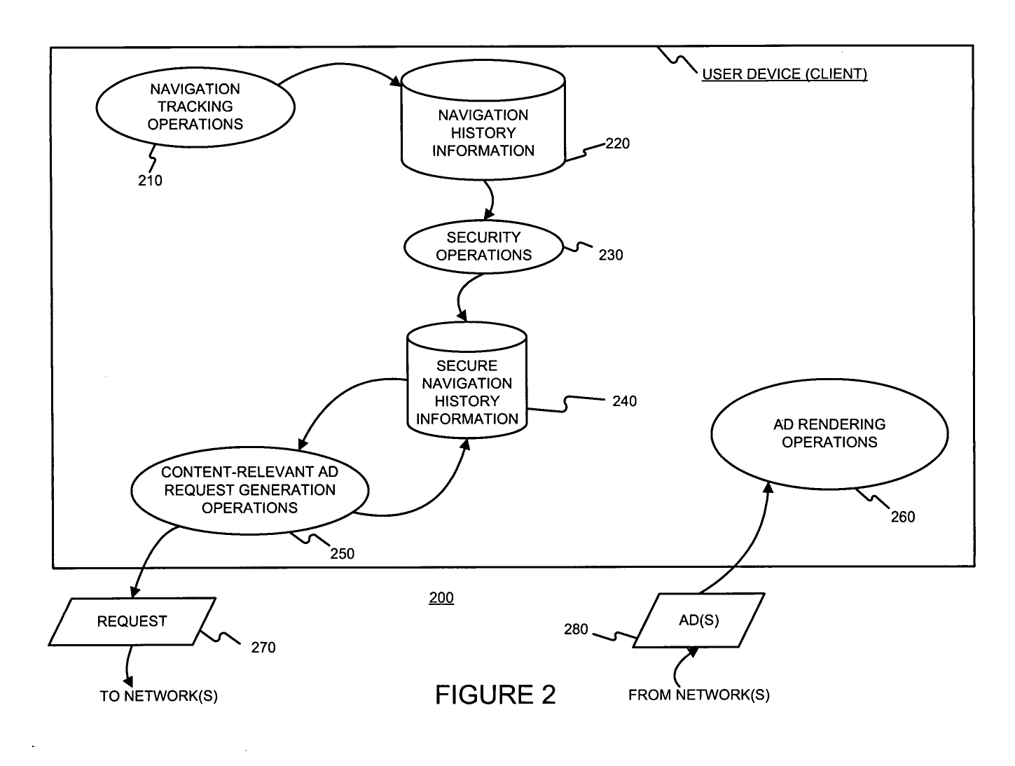

FIG. 2 is a bubble chart of exemplary user device (client) operations, and information used or generated by such operations consistent with the present invention. The following described operations of the user device take place in order for it to generate ad and content requests, as well as the navigation history information, and to receive and render ads relevant to the user's recent navigation history.

The user device environment 200 may include navigation tracking operation 210 which may track navigation and store it as navigation history information 220. The navigation history information may then be encrypted 230 and secured 240 for secure transmission across the network(s). The user device environment 200 may also include content-relevant-ad request operations 250 which sends request for ads to a content-relevant ad server via the network(s) 270, as well as an ad rendering operations 260 which accept ads from the content-relevant ad server via the network(s) 280, and renders them.

Navigation (e.g., browsing) tracking operations 210 may be used to track and record Websites and/or Web pages (recently) visited by the user device, and/or other (recent) user activities. These operations 210 may record various serving parameters such as URLs, search queries, time and date of search or request, geographical region, etc. This information may be stored as navigation history information 220. Security operations 230 may be used to encrypt the navigation history information 220 (e.g., for security reasons such as, avoiding abuse of private information, preventing use or access by unauthorized programs or Websites, etc.) The encrypted navigation history information may be stored as secure navigation information 240. A unique ID may be attached to the secure navigation history information 240 specific to the content-relevant ad delivery system 140 and only readable or accessible by C-RAN content servers 120.

When the user device makes requests 270 using content request generation operations 250 to the network(s), they 250 may provide the secure navigation history information 240 to C-RAN content servers 120 (or directly to content-relevant ad delivery system 140). Moreover, the user device may accept one or more ads 280 (e.g., as part of a requested document) from the network(s). The ad(s) may be presented to a user by ad rendering operations 260. For example, the ad(s) may be rendered on a requested Webpage.

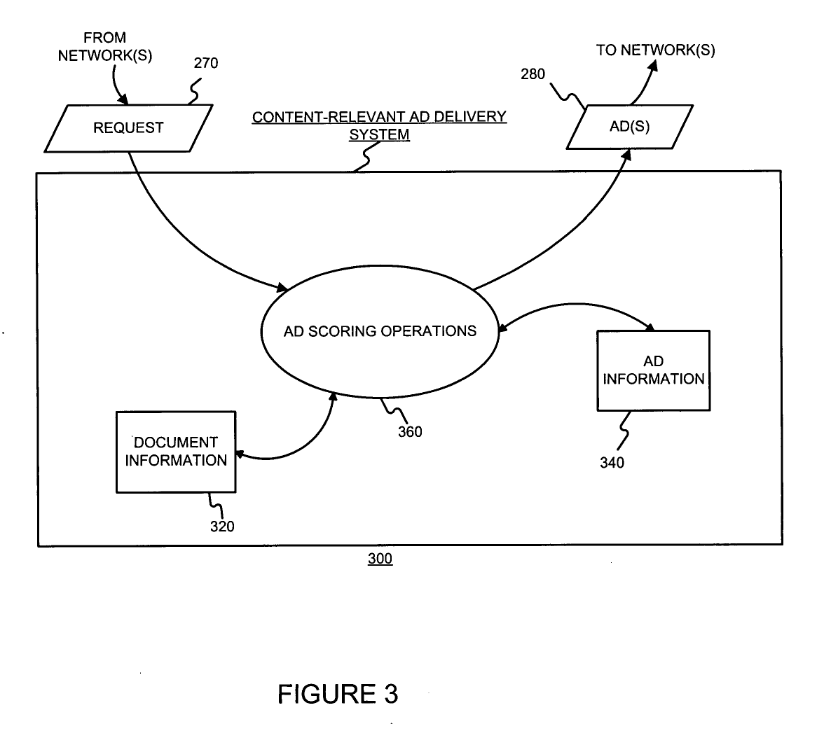

FIG. 3 is a bubble chart of exemplary content-relevant ad delivery operations, and information used or generated by such operations, consistent with the present invention. The content-relevant ad delivery system may include an ad scoring operations 360 that interact with document information 320 along with ad information 340 upon receiving requests from the networks 270. Subsequently, the content relevant ad delivery system may send ad(s) back to the networks.

Ad scoring operations 360 may process the incoming request 270 from the network(s) and send back to the network(s) one or more appropriate ad(s) 280. The ad scoring operations 360 may use navigation history information contained in or referenced by the request 270 to look up document information 320. The ad scoring operations 360 may then use the document information 320 and ad information 340 to determine a set of one or more relevant ads. If the incoming request 270 does not include navigation history information, then the ad 270 scoring operations 360 may use content information of the currently requested document, without the benefit of navigation history information, to generate a set of one or more ads 280. By going through this process, the user device can receive content and ads that reflect a user interest inferred from their navigation history.

### § 4.3 Exemplary Embodiments

§ 4.3.1 Exemplary Methods

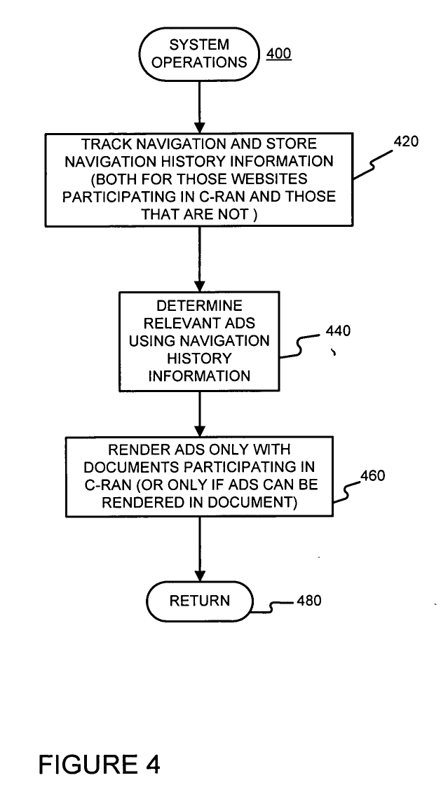

FIG. 4 is a flow diagram of an exemplary method 400 that may perform various components of a system consistent with the present invention. The advertising system, taken as a whole, may function to track user device navigation and store navigation history information, both for content servers (e.g., Websites) participating in C-RAN and those that do not. (Block 420) The navigation history information may then be used in a determination of relevant ad(s). (Block 440) Such ads may then be rendered only on documents participating in C-RAN. (Block 460)

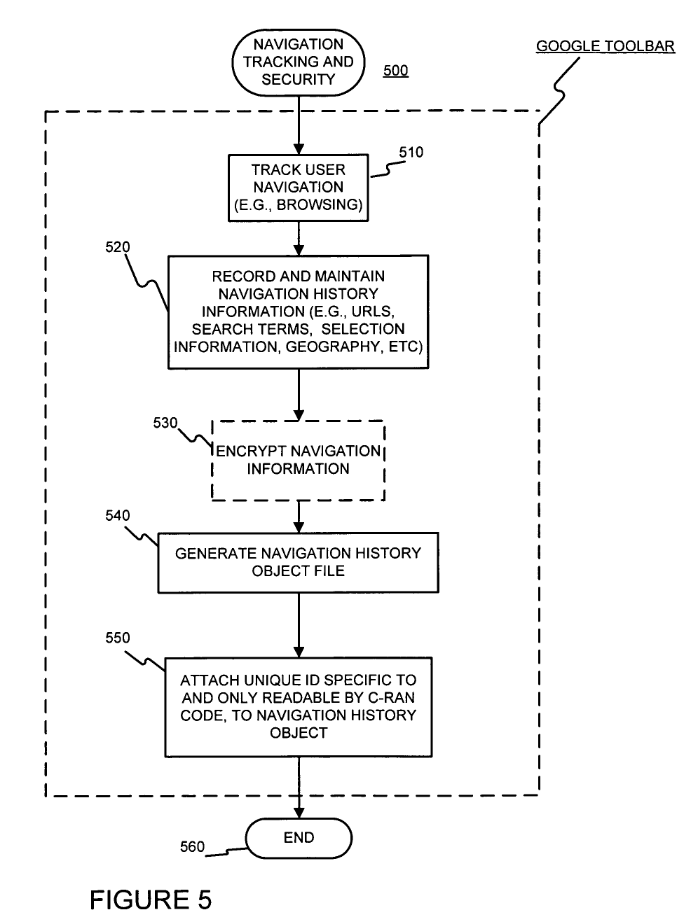

FIG. 5 is flow diagram of an exemplary method 500 that may be used to track user navigation and generate navigation history information in a manner consistent with the present invention. In particular, user device navigation, such as Internet browsing for example, is tracked. (Block 510) The method 500 may store and maintain all the (recent) navigation history information. (Block 520) The navigation history information may be encrypted. (Optional block 530) A navigation history object file may be generated. (Block 540) The method 500 may then attach a unique ID to the navigation history object. Preferably, the unique ID should be specific to, and only readable by, C-RAN code. (Block 550)

Referring back to block 510, user device navigation may be tracked by the user device's navigation tracking operations 210. (Recall FIG. 2.) For instance, whenever a user is browsing the Web, block 510 follows the user's activities and visited Webpages. The recently tracked information are subsequently stored and maintained for further processing.

Referring back to block 520, the navigation history information may include URLs, search terms, ad selection information, link selection information, user geography, etc.

Referring back to block 530, for added security, the navigation history information may be encrypted. Consequently, the possible abuse of history information from other programs or Websites is avoided.

Referring back to block 540, the navigation history information may be made available as an object file that should be suitable for easy reading and transmission across the network.

Finally, referring back to block 550, the unique ID may be used to ensure that while a user is navigating on documents (e.g., browsing on Websites) not supported by C-RAN, the Website will not be aware of, or will not have access to, the object file. However, if a user device loads a document (e.g., a Webpage on a Website) supported by C-RAN, the code in the document will look for and detect the object file which is accessible to it and readable by it.

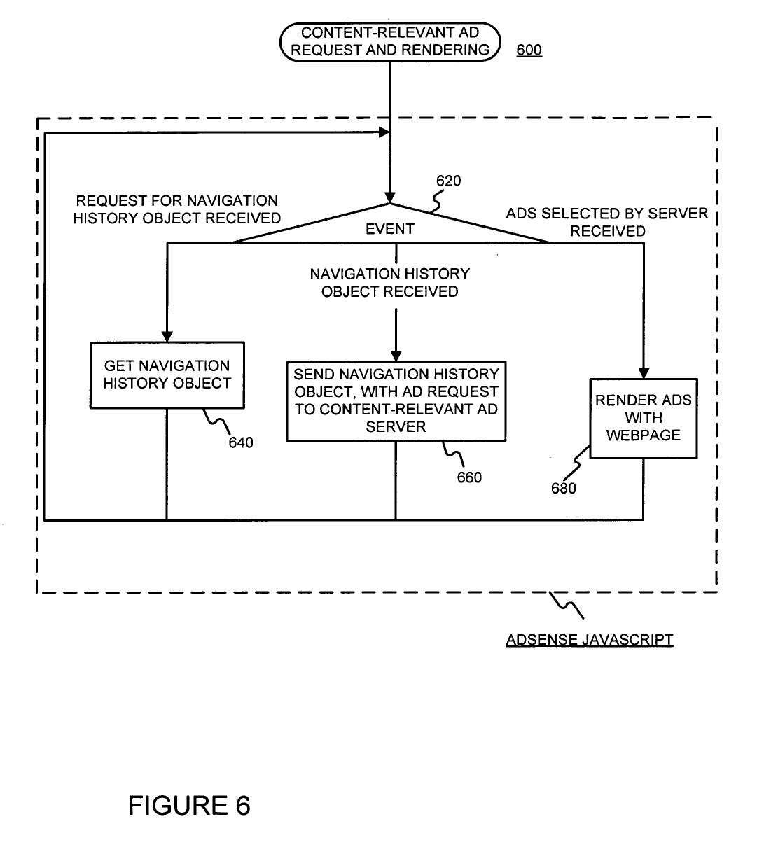

FIG. 6 is a flow diagram of an exemplary method 600 that may be used to provide information for an ad request and to render ads in a manner consistent with the present invention. The content-relevant ad request and rendering method 600 may be performed by the user device (client) 200. As illustrated in FIG. 6, various branches of the method 600 are performed upon occurrence of various events. (Block 620) If a request for the navigation history information object is received from a document (e.g., Webpage of a content server) participating in C-RAN, the object file is obtained. (Block 640) Subsequently, referring back to event block 620, when the requested navigation history object is received, the method 600 sends the navigation history object for use by the content-relevant ad delivery system. (Block 660) After the content-relevant ad delivery system receives and processes the navigation history information along with the ad request(s), it will send the ad(s) (directly, or via the content server) back to the user device. Referring back to event block 620, when the ad(s) are received, the method 600 may render them with the Webpage. (Block 680)

Referring back to block 640, the navigation history object request may be received from a browser operation on the user device. For example, the browser may generate the request when it runs executable code (e.g., Javascript) in the document from a C-RAN content server.

Referring back to block 660, the navigation history object may be sent by the user device directly to the content-relevant ad server, or indirectly, via the C-RAN content server.

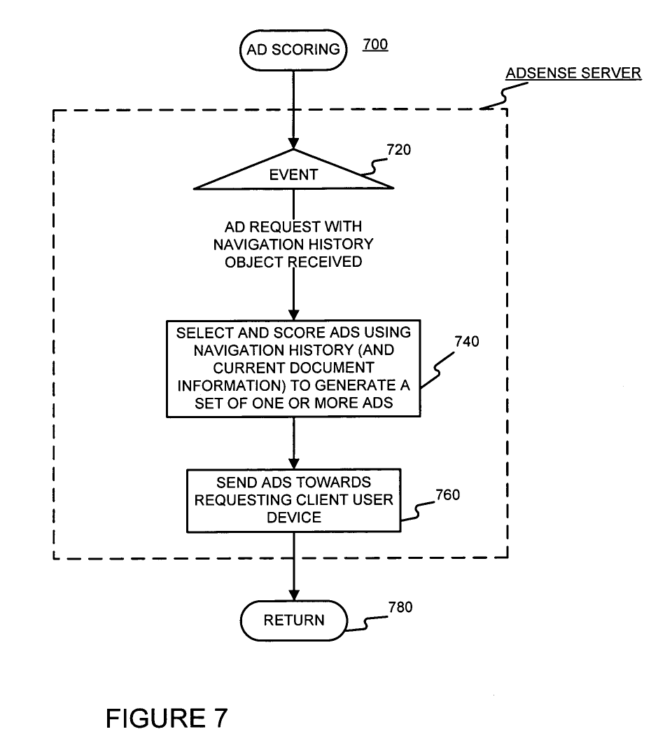

FIG. 7 is a flow diagram of an exemplary method 700 that may be used to generate a set of one or more ads using navigation history information in a manner consistent with the present invention. Specifically, the content-relevant ad server performs a number of acts in response to receiving an ad request with the navigation history object file. (Block 720) Specifically, the ad(s) may be selected and scored using the (recent) navigation history of the user. (Block 740) Once the ad(s) have been selected, they are sent to the user device to satisfy the request. (Block 760)

Referring back to block 740, the ad scoring may use additional information such as current document information, ad information (e.g., ad performance, ad offers), etc.

Note that the content-relevant ad delivery system can also receive requests from content servers participating in C-RAN but having no navigation history object file to send with the request. This could occur simply because a feature may have been turned off, or because the user device has not been tracking and storing navigation information. In such cases, the content-relevant ad delivery system may simply reply to the request with ads that are selected using content of the current document, or other parameters and have no navigation history information associated with them.

§ 4.3.2 Exemplary Communications

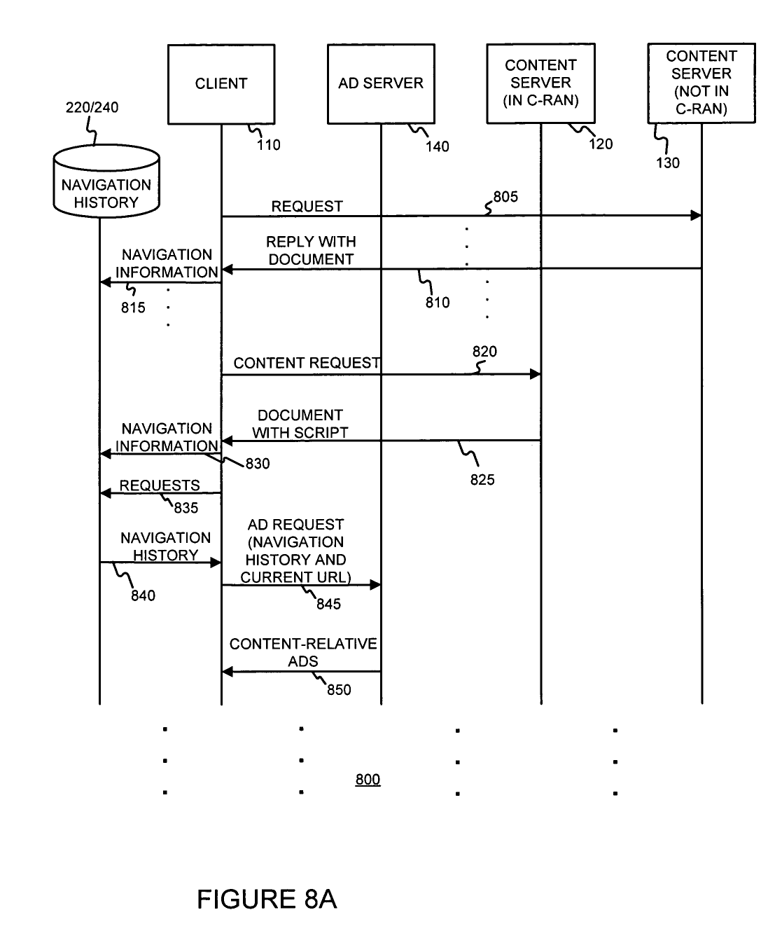

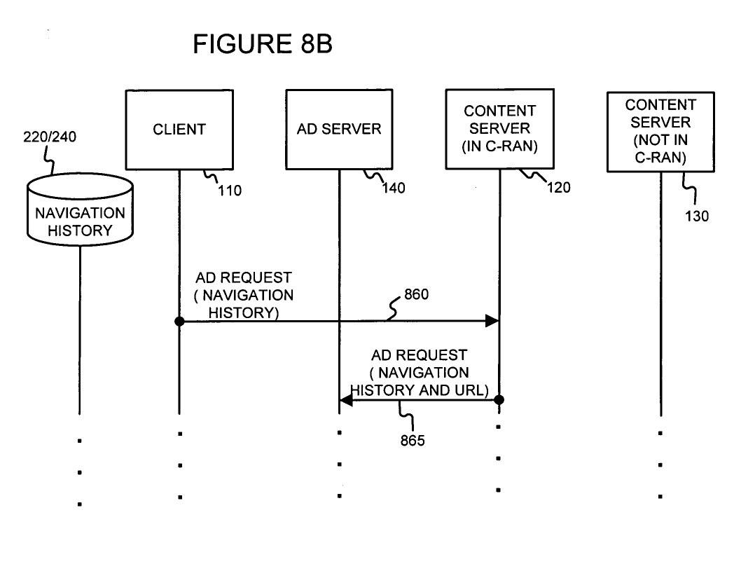

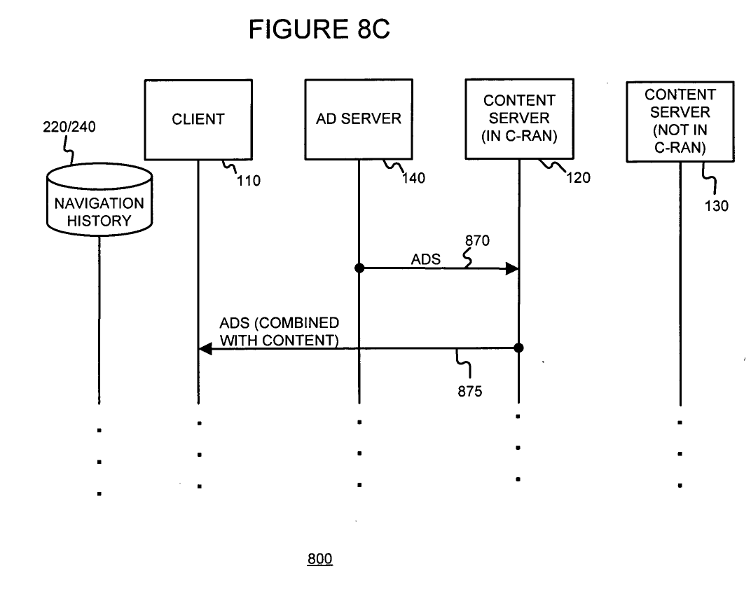

FIGS. 8A-8C are messaging diagrams illustrating the communication of various information among parties or entities in a manner consistent with the present invention. In particular, these figures illustrate flows of information (requests for content, ads, documents, etc.) among the user device and the various servers.

The environment in which the communication of a variety of information is taking place may include a number of parties or entities. The environment may include a navigation history 220/240 where navigation history information is maintained and processed. The environment may include a client 110 as described earlier and an ad server 140 where a variety of ads and pertinent information is stored and processed. The environment may also include content servers participating in C-RAN 120 and those that are not 130. The content servers may maintain a variety of document information that is stored and processed.

In FIG. 8A, the client 110 submits a request 805 for content or other information from the content server not participating in C-RAN 130. For example, this may occur when a user is browsing Websites that do not participate in C-RAN. To satisfy the request, the content server 130 may reply by providing content or other information 810 back to the user device 110. Document information 815 and/or other information about the request is stored as the navigation history information 220/240. The client 110 may also make requests 820 to content servers participating in C-RAN 120. For example, this may occur when the user is browsing Websites participating in C-RAN. To satisfy the request the content server 120 may reply with document information 825. The document information 825 may include executable code such as a script for requesting content-relevant ads, where the request may include user device navigation history information. More specifically, the document information and/or information about the request are provided as navigation information 830 stored in to the navigation history 220/240. When client 110 runs the executable code, it submits a request 835 for the navigation history object file. After the navigation history object 840 has been provided from the navigation history operations 220/240, the client 110 will send an ad request 845, including the navigation history object (and current URL), to the ad server 140. The ad server 140 replies by sending content-relevant ad(s) 850 back to the client 110 where the ads are rendered with the document (e.g., on the Webpage).

Various parts of the information may be communicated in other ways. For example, FIG. 8B shows alternative communications replacing message 845. More specifically, in FIG. 8B the client 110 sends an ad request, including the navigation history object file 860, to the content server participating in C-RAN 120. The content server 120 then sends the ad request 865, along with the navigation history object and the current document information (e.g., URL), to the ad server 140. Referring back to message 850 of FIG. 8A, the ad server 140 processes the information and sends the appropriate ads back to the client 110.

FIG. 8C shows alternative communications replacing message 850 of FIG. 8A. More specifically, in FIG. 8C, after the ad server 140 has received requests and pertinent information, it sends the ad(s) to the content server 120. The content server 120 sends the ads, along with requested content, back to the client 110 in order to satisfy its request.

§ 4.3.3 Exemplary Data Structures

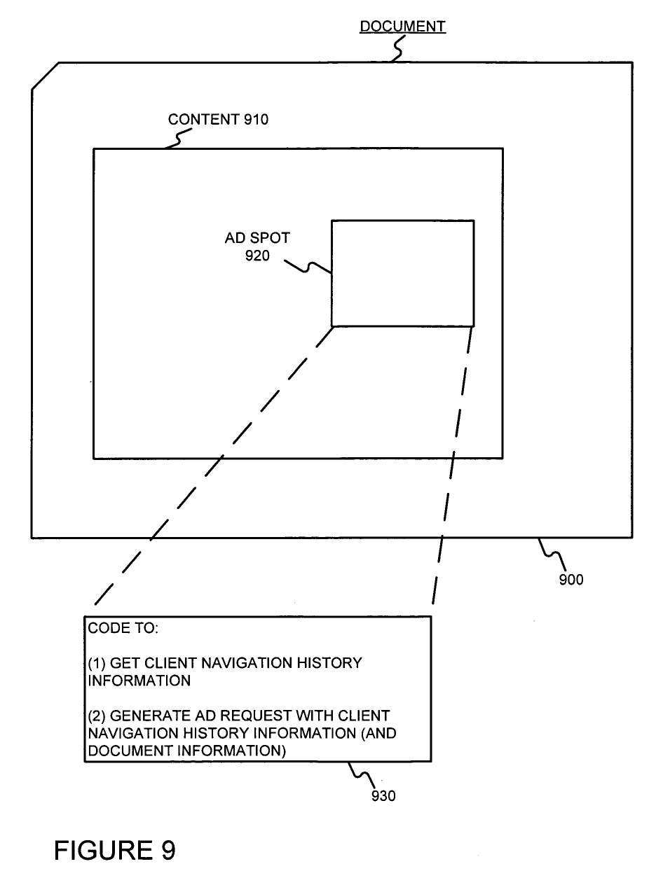

FIG. 9 illustrates a document (e.g., a Webpage) 900 including code for generating an ad request including client navigation history information.

The document 900 may include content 910 as well as an ad spot 920. The ad spot 920 may include code 930 for requesting ads.

In particular, the document 900 could be, for example, a Webpage participating in C-RAN that contains content 910 along with an ad spot 920. The content 910 may include a variety of information such as text, Weblinks, images, multimedia files, and ad spots. The ad spot 920 may contain code for obtaining the client navigation history information, and code for generating the ad request with client navigation history information and document information 930. Therefore, when the document is loaded in the user's browser, the browser will run ad spot code. The executed code initiates the procedure of obtaining and rendering ads relevant to the user's navigation history and current URL. However, if the document is a Webpage not participating in C-RAN, the ad spot will not contain the code for obtaining the navigation history information.

§ 4.3.4 Exemplary Apparatus

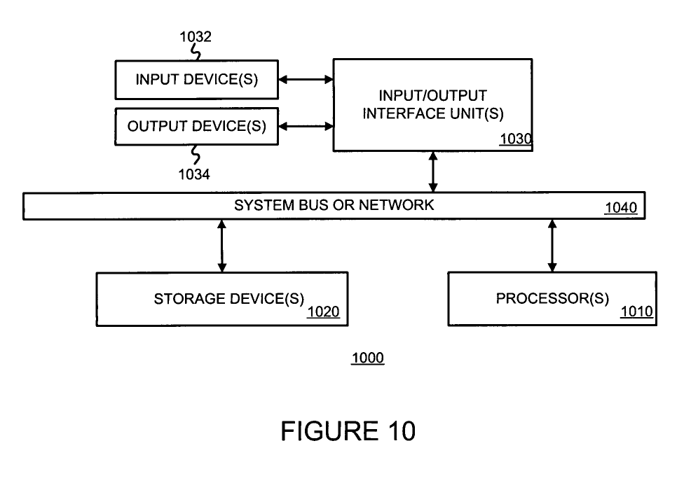

FIG. 10 is high-level block diagram of a machine 1000 that may effect one or more of the operations discussed above. The machine 1000 basically includes one or more processors 1010, one or more input/output interface units 1030, one or more storage devices 1020, and one or more system buses and/or networks 1040 for facilitating the communication of information among the coupled elements. One or more input devices 1032 and one or more output devices 1034 may be coupled with the one or more input/output interfaces 1030.

The one or more processors 1010 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 1020 and/or may be received from an external source via one or more input interface unit s 1030.

In one embodiment, the machine 1000 may be one or more conventional personal computers. In this case, the processing units 1010 may be one or more microprocessors. The bus 1040 may include a system bus. The storage devices 1020 may include system memory, such as read only memory (ROM) and/or random access memory (RAM). The storage devices 1020 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1032, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 1010 through an appropriate interface 1030 coupled to the system bus 1040. The output devices 1034 may include a monitor or other type of display device, which may also be connected to the system bus 1040 via an appropriate interface. In addition to (or instead of) the monitor, the personal computer may include other (peripheral) output devices (not shown), such as speakers and printers for example.

§ 4.3.5 Refinements and Alternatives

There are various alternative ways to provide the client navigation history information to the ad delivery system. For example, the navigation history already transmitted (separate from the ad request) by the current client (user device) implementation could simply be forwarded to C-RAN ad servers. At a C-RAN ad server, the navigation history information could be correlated with an ad request from a user device using Internet protocol (IP) address, a media access control (MAC) address, cookies, or a small identifier supplied via content relevant javascript to the client's toolbar. This slightly more complicated approach of sending the navigation history information independent of ad requests (e.g., in a continuous and separate stream) might require little or no additional participation of client (toolbar) code. For example, to display PageRank for a Webpage, the current Google toolbar already transmits navigation event information directly to navigation history servers. This navigation history could be forwarded directly to the C-RAN ad servers. The navigation history can be analyzed, stored, and processed on C-RAN ad servers prior to any specific ad request. Such an alternative may have better performance characteristics in terms of reducing the amount of data that is contained in an ad request, reducing the amount of computation needed at the time of an ad request, and therefore lowering the amount of time between an ad request and the selection and rendering of targeted ads on the client device.

Similarly, selection of ads for a document need not happen after that document is provided to the client. For example, if toolbar navigation history information is sent independently (e.g., continuously), ad selection can be done during navigation, and long before ad display happens. When an opportunity for showing ads finally occurs, the pre-computed ads can be provided at that time. This might allow more time to do more sophisticated ad computation, such as computing ad copy; searching larger or external databases for ads; or computing or selecting coupons. In such an embodiment, a preliminary set of pre-computed ads might be filtered, rescored, or otherwise refined using document information of the document the ads are to be rendered with.

Furthermore, navigation history information need not be collected by a toolbar. It can be collected using a proxy server, a browser helper object, or by a custom browser implementation. One or more of these alternative approaches can be considered. They are merely different ways of providing the same functionality.

Moreover ads do not need to be limited to Webpages of Websites. For example, ads may be rendered with or in other documents such as relevant discussion (chat) groups, relevant audio or video programming, email or other applications. Ads based on navigation history could also be shown in a popup window outside the browser, in an ad pane within a browser, or by inserting them in the Webpage content itself.

The principle of using navigation history information can be used to select other kinds of useful content besides ads. For example, it can be used to find relevant (not-for-pay) Websites, relevant email, and relevant people. It can also be used to present coupons. For example, a user with a very long history browsing for prices of a specific product may qualify for a coupon offer that is not presented to a user who has not comparison-shopped as long.

Navigation history information to help select relevant content does not need to be limited to browsed Webpages. For example, navigation history information can include recently read emails, recently edited documents, and recently sent instant messages, etc.

Alternatively, or in addition, information from previous user behavior other than user navigation history may be used when determining ads to serve. Such previous user behavior may include previous queries submitted by the user, previous selections (e.g., of ads, documents, etc) by the user, etc.

§ 4.4 Example of Operations

An example of operations of an exemplary embodiment consistent with the present invention is now provided. Suppose a user has been browsing on the Internet for a variety of information on Epson printers. The user could be interested in purchasing a new printer or examining accessories and supplies for their existing printer. Meanwhile, the navigating tracking operation 210 tracks and records the URLs of the visited Webpages, and perhaps other pertinent information, as navigation history information. (Recall, e.g., 220 of FIG. 2.) Suppose that later the user is browsing on a Website participating in C-RAN that has information about paper. The user device (client) may process the recorded navigation history information (Recall, e.g., 240.) and generate a content-relevant ad request.

Once the request is received by the content-relevant ad delivery system 300, the content-relevant ad delivery system 300 uses the navigation history information, perhaps in addition to other information, to generate a set of one or more ads. (Recall, e.g., 280) Appropriate ads will be sent back to the user device for rendering.

Therefore, instead of getting ads concerning wide-ranging goods, such as “writing paper”, “printer paper”, “recycled paper”, “paper cutters” and so on, the user device will get ads that are adapted to the recent navigation history information. For example, the ads might include much more relevant ads, such as “Epson paper”, “best paper for printers”, “Epson R800 paper feeders”, and so on. The ads the user will see are much more relevant to their (current) interest, as inferred from their navigation history. Since the ads should be much more useful, it is more likely that the user will select the ad.

Consider a different user arriving at the same Website perhaps. Assume that this other user was recently browsing Webpages about paper airplanes. This user could be provided with a completely different set of ads such as, “model airplane material”, “paper folding books”, and so on. Again, the ads are better targeted and tailored to the user's recent history.

### § 4.5 CONCLUSIONS

As can be appreciated from the foregoing disclosure, the invention can be used to expand and improve the targeting of ads using the (recent) navigation history of the user. The ads provided to the user should be more appealing since they should better reflect the user's (recent) preferences, inquiries, interest and so on.

What is claimed is:

1. A method comprising:
a) tracking, with a client device, a history of documents of a first type and documents of a second type requested by the client device;
b) generating and storing, on the client device, navigation history information from the tracked history of documents; and
c) generating, after requesting a document of the first type by the client device, an ad request, wherein the ad request includes at least some of the navigation history information.

2. The method of claim 1 further comprising:
d) forwarding, from the client device, the ad request towards an ad delivery system.

3. The method of claim 2 wherein documents of the first type have an ad serving agreement with the ad delivery system, and
wherein documents of the second type have no ad serving agreement with the ad delivery system.

4. The method of claim 3, wherein the ad delivery system is a content-relevant ad delivery system, and
wherein the ad request includes document information.

5. The method of claim 2 further comprising:
e) determining, with the ad delivery system, a set of one or more ads using at least some of the at least some navigation history information in the ad request.

6. The method of claim 5 further comprising:
f) forwarding, from the ad delivery system, the determined set of ads towards the client device.

7. The method of claim 6 further comprising:
g) receiving, with the client device, the determined set of ads; and
h) rendering, with the client device, the determined set of ads with the document of the first type loaded.

8. The method of claim 1 wherein the act of generating and storing, on the client device, navigation history information includes encrypting the navigation history information.

9. The method of claim 8 wherein the act of generating and storing, on the client device, navigation history information includes attaching a unique identifier to the navigation history information.

10. The method of claim 1 wherein the navigation history information includes a unique identifier of the client device.

11. The method of claim 1 wherein the navigation history information includes an Internet protocol address of the client device.

12. The method of claim 1 wherein the navigation history information includes a media access control address of the client device.

13. The method of claim 1 wherein the navigation history information includes a unique identifier of a browser of the client device.

14. The method of claim 1 wherein the navigation history information includes a unique identifier of a browser toolbar of the client device.

15. The method of claim 1 wherein the documents include Webpages.

16. The method of claim 1 wherein the documents include emails.

17. A method comprising:
a) tracking, with a client device, a history of documents of a first type and documents of a second type requested by the client device;
b) generating, on the client device, navigation history information from the tracked history of documents;
c) forwarding, from the client device, at least some of the navigation history information, including data for matching the navigation history with a later ad request; and
d) generating, after requesting a document of the first type by the client device, an ad request, wherein the ad request includes data for matching the ad request with an earlier navigation history.

18. The method of claim 17 further comprising:
e) forwarding, from the client device, the ad request towards an ad delivery system.

19. The method of claim 18 wherein documents of the first type have an ad serving agreement with the ad delivery system, and
wherein documents of the second type have no ad serving agreement with the ad delivery system.

20. The method of claim 19, wherein the ad delivery system is a content-relevant ad delivery system, and
wherein the ad request includes document information.

21. The method of claim 18 further comprising:
f) matching, with the ad delivery system, the ad request with the navigation history information using (i) the data for matching the navigation history with a later ad request, and (ii) the data for matching the ad request with an earlier navigation history; and
g) determining, with the ad delivery system, a set of one or more ads using at least some of the at least some navigation history information in the ad request.

22. The method of claim 21 further comprising:
h) forwarding, by the ad delivery system, the determined set of ads towards the client device.

23. The method of claim 22 further comprising:
i) receiving, with the client device, the determined set of ads; and
j) rendering, with the client device, the determined set of ads with the document of the first type loaded.

24. A machine-readable medium having stored thereon a machine-readable data structure comprising:
a) content information; and
b) machine-executable code which, when implemented by a machine,
i) obtains client device navigation history information, and
ii) generates an ad request including at least some of the client device navigation history information,
wherein the machine-executable code is included in documents of a first type, and
wherein the navigation history includes documents of the first type and documents of a second type that had been requested by the client device.

25. The machine-readable medium of claim 22 wherein documents of the first type have an ad serving agreement with an ad delivery system, and
wherein documents of the second type have no ad serving agreement with the ad delivery system.

26. The method of claim 25, wherein the ad delivery system is a content-relevant ad delivery system, and
wherein the ad request includes document information.

27. Apparatus comprising:
a) means for saving navigation history information about documents of a first type and documents of a second type requested by the device; and
b) means for generating an ad request, including at least some of the navigation history information, when the device requests a document of the first type but not when the device loads a document of the second type.

28. The apparatus of claim 27 wherein documents of the first type have an ad serving agreement with an ad delivery system, and
wherein documents of the second type have no ad serving agreement with the ad delivery system.

29. The apparatus of claim 28, wherein the ad delivery system is a content-relevant ad delivery system, and
wherein the ad request includes document information.

30. A method for targeting online advertisements for a document being accessed by a user, the method comprising:
a) accepting document information associated with the document; and
b) selecting a set of advertisements using at least the document information and information from previous user behavior of the user.

31. The method of claim 30 wherein previous user behavior includes other documents previously accessed by the user.

32. The method of claim 30 wherein the previous user behavior includes previous queries submitted by the user.

33. The method of claim 30 wherein the previous user behavior includes previous selections by the user.

34. The method of claim 30 wherein the previous selections include at least one of (A) previous ad selections, and (B) previous document selections.

35. The method of claim 30 wherein the publisher document information includes content of the publisher document.

36. Apparatus for targeting online advertisements for a publisher document being accessed by a user, the apparatus comprising:
a) an input for accepting document information associated with the publisher document; and
b) means for selecting a set of advertisements using at least the document information and information from previous user behavior.

37. The apparatus of claim 36 wherein the previous user behavior includes documents previously visited by the user.

38. The apparatus of claim 36 wherein the previous user behavior includes search queries previously submitted by the user.

39. The apparatus of claim 36 wherein the previous user behavior includes selections previously made by the user.

40. A machine-readable medium having stored thereon machine-executable instructions which, when executed by a machine, perform a method comprising:
a) tracking, with a client device, a history of documents of a first type and documents of a second type requested by the client device;
b) generating and storing, on the client device, navigation history information from the tracked history of documents; and
c) generating, after requesting a document of the first type by the client device, an ad request, wherein the ad request includes at least some of the navigation history information.

41. A machine-readable medium having stored thereon machine-executable instructions which, when executed by a machine, perform a method comprising:
a) tracking, with a client device, a history of documents of a first type and documents of a second type requested by the client device;
b) generating, on the client device, navigation history information from the tracked history of documents;
c) forwarding, from the client device, at least some of the navigation history information, including data for matching the navigation history with a later ad request; and
d) generating, after requesting a document of the first type by the client device, an ad request, wherein the ad request includes data for matching the ad request with an earlier navigation history.

42. A machine-readable medium having stored thereon machine-executable instructions which, when executed by a machine, perform a method comprising:
a) accepting document information associated with the publisher document; and
b) selecting a set of advertisements using at least the document information and information from previous user behavior of the user.
